(19) United States
(12) Patent Application Publication
(10) Pub. No.: US 2018/0124452 A1
(43) Pub. Date: May 3, 2018

(54) SYSTEM AND METHOD FOR LOADING USER INTERFACE

(71) Applicant: ARRIS Enterprises LLC, Suwanee, GA (US)

(72) Inventors: Harimohan Theyyandavida, Bangalore (IN); Parthipan Ponnuraj, Bangalore (IN)

(21) Appl. No.: 15/341,198

(22) Filed: Nov. 2, 2016

(51) Int. Cl. H04N 21/431; H04N 21/422; H04N 21/482; H04N 21/84

(52) U.S. Cl. CPC H04N 21/4312; H04N 21/84; H04N 21/482; H04N 21/42204

(57) ABSTRACT

A system and method of encoding and transmitting image data for a user interface of a device using a single transport stream is provided. The image data is embedded with an identification code and then encoded into a data package. The data package is transmitted in a transport stream to a device. The device may then decode the data package to obtain the original image data. After obtaining the image data, the device may select an image of the data package to display based in an identification code.

### BACKGROUND

The present invention generally deals with systems and methods for transmitting graphical user interface (GUI) screens as video frames within a custom video stream.

For today's digital media service, set top boxes are used to decode hundreds of channels, decrypt premium channels, stream online content, and provide upstream communications for video on demand (VOD).

The incoming bandwidth of a set top box providing these features is increasingly strained as more and more content is provided. Each new content stream utilizes more of the limited incoming bandwidth available. The strain on the incoming bandwidth is also increased by the large amount of data that needs to be transmitted for high definition content.

Currently, display menus and programming guides are transmitted from the head-end to the set top box as multiple video streams. Each screen of the menu is transmitted on a separate channel to the set top box. When a menu is activated, the set top box tunes to the channel corresponding to the current menu screen to access the GUI graphics. Once accessed, the set top box displays the graphics as a GUI screen. If a new menu is selected, the set top box tunes to the new corresponding channel to access and display the graphics for the new GUI screen.

Alternatively, some set top boxes come equipped with an application to display GUIs. The application displays GUIs based on the graphics it currently has cached. The cached graphics need to be frequently updated so the application can display current information. The graphics and information needed by the application are received and updated via a data stream, which is then processed, cached, and displayed by the application.

A problem with the head-end providing a GUI to a set top box is that each menu screen is transmitted on a separate channel. The head-end transmitting each menu screen as a separate video channel uses a large portion of the already limited amount of bandwidth available. Therefore the use of enhanced graphics and GUIs is restricted by the available bandwidth, and this restriction also results in unresponsive and clunky set top box GUIs.

Another problem with the head-end providing a GUI to a set top box is that bandwidth becomes even scarcer with multiple users. Each user added requires a minimum amount of bandwidth to be serviced, which decreases the amount of bandwidth that is available to each user.

Yet another problem with GUIs using an application installed on the set top box is that a constant data stream is required to keep the menu graphics and information current. Using a data stream to transmit the menu graphics and information is an inefficient and slow method, resulting in an unresponsive and clunky set top box GUI.

Accordingly, for at least the foregoing reasons there exists a need for providing GUI graphics from a head-end without utilizing a large portion of the available bandwidth.

### SUMMARY

The present invention is drawn to a system and method for transmitting image data for an entire user interface to a device using a single MPEG transport stream.

An aspect of the present invention is drawn to a system and method of encoding and transmitting image data for a user interface of a device using a single transport stream. The image data is embedded with an identification code and then encoded into a GUI group of pictures. The GUI group of pictures is transmitted in a transport stream to a device. The device may then decode the GUI group of pictures to obtain the original image data. After obtaining the image data, the device may cache the image data to be retrieved and used at a later time based on the identification code embedded into each image.

A method of providing a graphical user interface is described that comprises associating a hierarchy of video images with a respective hierarchy of identification codes; associating user remote control selections with traversing the hierarchy of identification codes; receiving a remote control selection, wherein a user's remote control selection operates to traverse the hierarchy of identification codes; determining the identification code selected by the user's remote control selection; and selecting one video image within said hierarchy of video images corresponding to said identification code.

Also described is a method of generating a graphical user interface that comprises creating a set of video images that comprises the images of a graphical user interface menu; associating the set of video images with a respective hierarchical structure; associating the hierarchy of video images with a respective hierarchy of identification codes; encoding the video images; and embedding an associated identification code into each encoded video image. A second set of images may also be similarly processed to provide an alternative graphical user interface operating in the same hierarchical structure.

A system aspect of this invention is drawn to a video receiver device comprising: a receiver operable to receive an encoded data package having a set of discrete encoded video images and a corresponding set of identification codes, each discrete encoded video image corresponding to an image of a graphical user interface; a decoder operable to decode the encoded data package to obtain decoded video image data, wherein each decoded video image is associated with a corresponding identification code; a memory storing user interface instructions; a controller operable to associate the user interface instructions with said decoded video image and said associated identification code to generate a graphical user interface package; a receiver operable to receive user control signals; and wherein said graphical user interface package enables input of user control signals to control the graphical user interface based, at least in part, on a user control signal and at least one identification code.

A method of supporting a graphical user interface is described that comprises receiving a transport package having a header and a payload, the payload corresponding to a data package, the data package having been created based on a set of encoded images, the set of encoded images corresponding to a set of graphical user interface images and respective identification codes, unpack a transport package to obtain the data package; decoding the data package to obtain the set of image data and respective identification codes; storing the set of image data and identification codes; receiving an instruction from a user; and selecting one of the menu images based at least in part on upon the user instruction and the identification codes.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a block diagram of a head-end operable to transmit an encoded user interface to a user, in accordance with aspects of the present invention;

FIG. 2 illustrates a block diagram of a graphical user interface in accordance with aspects of the present invention;

FIG. 3 illustrates the encoding flow for a graphical user interface such as that shown in FIG. 2;

FIG. 4 illustrates an example hierarchical block diagram of a user interface such as that shown in FIG.2; and

FIG. 5 illustrates the process flow for a user's interaction with a user interface implemented in accordance with this invention; and

FIG. 6 illustrates a block diagram of the headend and set to box system operable to provide a user interface in accordance with this invention.

### DETAILED DESCRIPTION

Aspects of the present invention are drawn to a system and method for using a single video stream to transport image data to a set top box to be used in a graphical user interface without occupying a large amount of bandwidth. In other words, the data for graphics of the multiple menus of a GUI on a set top box are supplied in a single video stream. In an example embodiment, these GUI menu image data are provided in a group of pictures of an MPEG encoded transport stream.

In accordance with a first aspect of the present invention, an image processor and encoder are used at the head-end of a content transmitter. When the image processor receives image data that will be used in a GUI of a set top box, it begins creating video frames using the image data.

The video frames are then sent to the encoder which embeds identification codes into each video frame. Frames are then encoded into an MPEG group of pictures (GoP). The GoP is then placed in a transport stream to be transmitted to a set top box.

When the set top box receives the transport stream, it decodes the transport stream to extract the GoP of interest. After the GoP has been extracted, each frame in the group of pictures is stored into memory along with the identification codes retrieved from the frame. When a GUI is activated, a controller can look up identification codes for the required GUI screen, via a GUI component. After looking up the identification codes, the controller can retrieve the video frames based on their identification code and extract the image data using an image processor. Once the original image data is extracted, the controller can create a GUI screen using the image data and transmit it to a display.

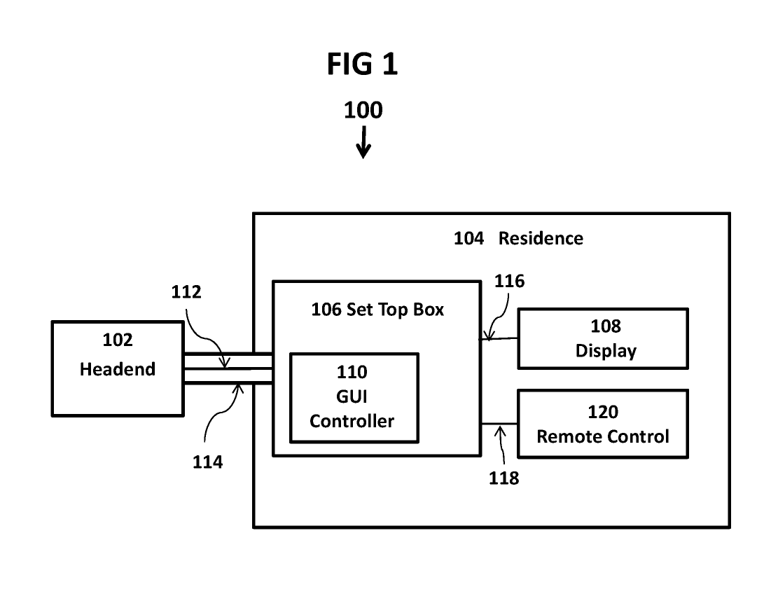

Example systems in accordance with the present invention will now be described with reference to FIGS. 1-6.

FIG. 1 illustrates a block diagram 100 of a GUI transport stream being transmitted from a head-end to a user, in accordance with aspects of the present invention.

As illustrated in the figure, block diagram 100 includes a head-end 102, a residence 104 and a communication line 114. Residence 104 further contains a set top box 106 and a display 108. Set top box 106 further contains GUI controller 110.

Head-end 102 is operable to transmit a plurality of data streams to set top box 106, via a communication line 114, which may be any known type of wireless or wired communication line. Head-end 102 is additionally operable to transmit transport stream 112 to set top box 106 via communication line 114.

Set top box 106 is operable to receive a plurality of data streams as well as transport stream 112 from head-end 102. Set top box 106 is additionally operable to tune to any one of plurality of data streams or transport stream 112 based on an input from a user. Set top box 106 is further operable to transmit video data to display 108, via a communication line 116, which may be any known type of wireless or wired communication line is further operable to receive communications from remote control 120, via communication path 118. It is well known to those skilled in the art that a variety of possible remote control interfaces are possible, such as infrared, RF4CE, as well as others.

Display 108 is operable to receive and display data from set top box 106.

Set Top Box 106

GUI controller 110 is operable to provide information for display 108 pertaining to the plurality of data streams being transmitted to set top box 106 by head-end 102. Those skilled in the art will understand that other information may also be included in the GUI information, such as promotions or other material.

Transport stream 112 contains data packages to be used by GUI controller 110.

In operation, head-end 102 transmits a plurality of video streams to set top box 106 of residence 104, via line 114. Each of the video streams contains data for an individual program. When a user selects a new program to display, set top box 106 acquires the desired video stream, for example an MPEG transport stream. Set top box 106 then transmits the data from the corresponding video stream to display 108, via line 116, e.g., switching video data streams to enable the user to watch different television programs.

In addition to transmitting video streams for each available program, head-end 102 also transmits transport stream 112 comprising graphical images and identification codes required by GUI controller 110. When a user enables a GUI on display 108, set top box 106 tunes to transport stream 112 to obtain the graphical images and data packages codes required by GUI controller 110. Set top box 106 can then transmit the graphical images from GUI controller 110 to be displayed on display 108, via line 116.

While this aspect of the present invention has been presented in terms of an MPEG transport stream, those skilled in the art will understand that other methods of transporting a GoP are readily available and are equally as amenable for the implementation of this aspect of the invention.

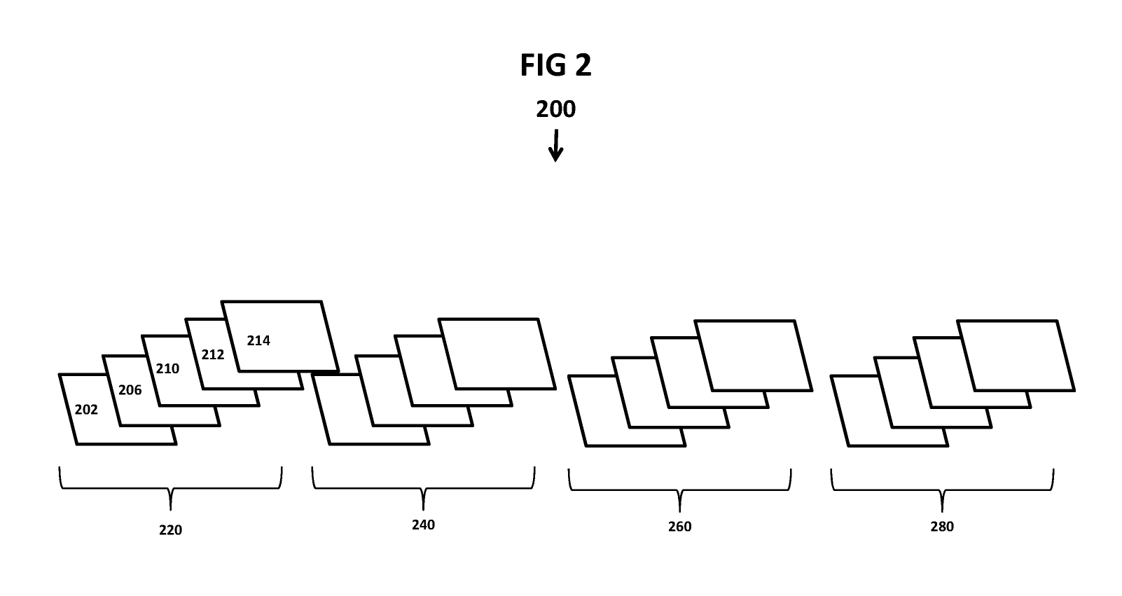

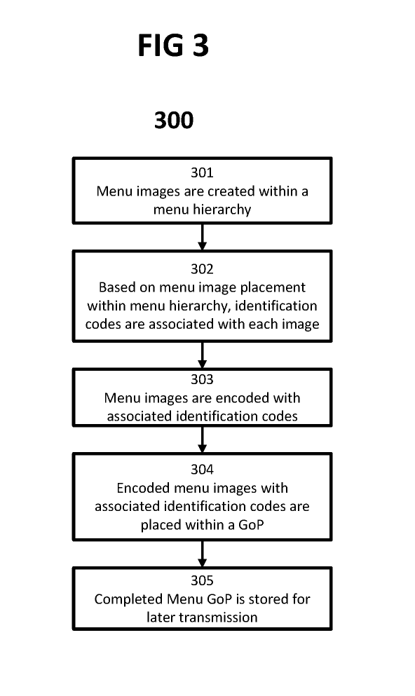

The construction of transport stream 112 and its contents will now be further described with additional reference to FIGS. 2-3.

FIG. 2 illustrates a menu package 200 consisting of four data packages, in accordance with aspects of this invention. FIG. 3 illustrates the construction and encoding of a data package 200, in accordance with aspects of the present invention.

The encoding and decoding of a data package will now be discussed with additional reference to FIG. 3.

As illustrated in FIG. 2, menu package 200 contains: a plurality of frames—a sample of which are indicated as an image 202, an image 206, an image 210, an image 212, and an image 214 within a GoP 220. As further indicated in FIG. 2, the other GoPs have similar structures, GoP 240, GoP 260, and GoP 280.

In the field of video compression a video frame is compressed using different algorithms with different advantages and disadvantages, centered mainly on the amount of data compression possible. Within the MPEG compression standard, different algorithms are used to compress video frames to generate different frame types.

With respect to aspects of the present invention, head-end 102 will receive image data and compress the image data for transport. For purposes of discussion an example embodiment using the MPEG compression standard will be described herein. It should be noted however, that any compression standard that encodes video data into discrete encoded image packages may be used in accordance with aspects of the present invention.

In an example MPEG embodiment, each frame in the GOP has an identification code embedded to identify the frame. The flow of FIG. 3 will be used to illustrate a process for creating the completed transport stream 112 for a menu package 200. With additional reference to the menu package structure of FIG. 2, at STEP 301 head-end 102 creates a collection or set of menu images that comprise a menu hierarchy. The frames might reflect the menu images consistent with a user accessing a Video On Demand Service, or accessing a current program listing.

At STEP 302 the menu images have an identification code associated with each image that is consistent at least with its placement within the menu hierarchy identified in step 301. As would be obvious to one skilled in the art, the identification codes may be completely unique within the menu package, or a frame's code may depend upon its placement within a larger structure.

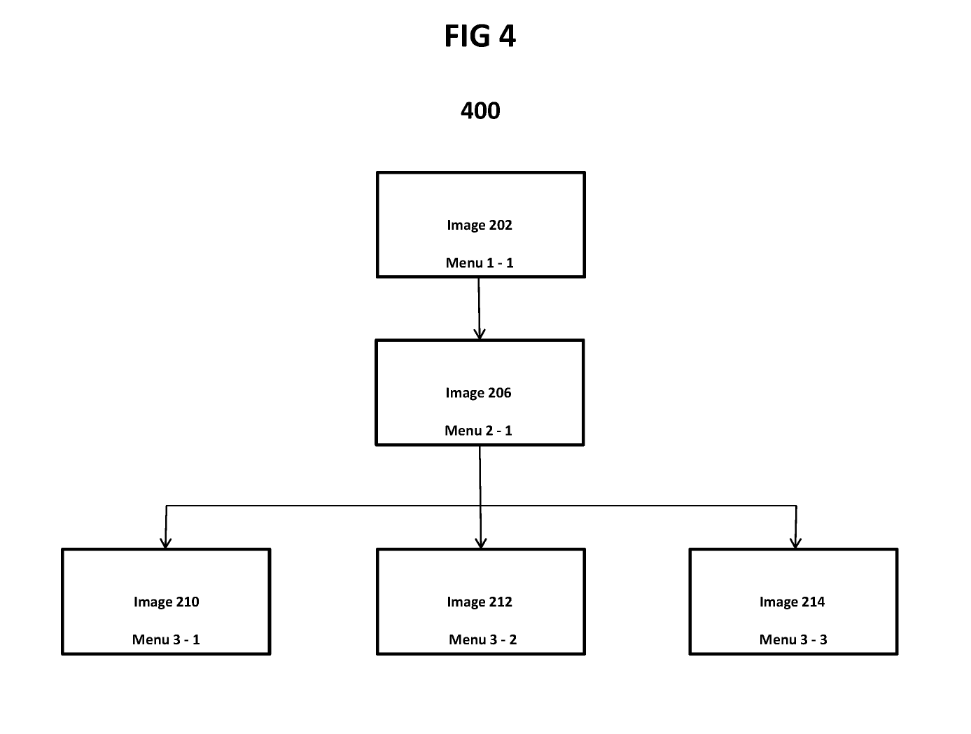

At STEP 303 the menu images are encoded for transport with their associated identification codes. Referring to the menu images of FIG. 2, an example embodiment of headend 102 encodes image 202 as an I-Frame. Next, head-end 102 encodes image 206 as a B/P-Frame, and image 310 as a P-Frame. Finally, head-end 102 encodes image 214 as an I-Frame. After encoding the images, head-end 102 will embed an identification code into each frame so they may be identified later. In this example embodiment, each identification code in the group of pictures corresponds to a frame containing an image to be used by menu 400 of FIG. 4.

At STEP 304, once the identification codes are embedded, head-end 102 creates GUI GoP 220 based on the group of pictures.

At STEP 305, the completed GUI GoP 220 is stored for later transmission. As one skilled in the art would understand, the GoP could also be transmitted immediately without storage in transport stream 112 to set top box 106 via line 114.

Each GUI group of pictures created by head-end 102 corresponds to image data for a GUI menu. For purposes of discussion, in this example embodiment, let GUI GoP 220 correspond to menu block diagram 400 of FIG. 4.

When set top box 106 receives transport stream 112, it unpackages the stream to obtain GUI GoP 220. Set top box 106 then decodes GUI GoP 220 to obtain each frame in the group of pictures. Set top box 106 decodes and caches the frames from each of GUI GoP 240, GUI GoP 260, and GUI GoP 280 as described above.

FIG. 4 illustrates a menu block diagram 400 of the GUI supported by GUI controller 110, in accordance with aspects of the present invention.

As illustrated in the figure and referring to the images of FIG. 2, menu block diagram 400 includes an image 202, an image 206, an image 210, an image 212, and an image 214.

Image 202 is the first menu screen to be displayed when GUI controller 110 of FIG. 1 is enabled corresponding to Menu 1-1. Image 206 is a sub-menu of Menu 1-1 corresponding to image 202, denoted Menu 2-1. Image 210, image 212, and image 214 are each sub-menus of image 206, denoted Menus 3-1, 3-2 and 3-3 respectively.

Referring back to FIG. 1, suppose a user is watching a television program that just ended and the user would like to watch another program but is unsure of what is available. Unsure of the programs that are currently available, the user decides to use a GUI to search for another program, pressing an appropriate button on a remote control 120. When GUI controller 110 is enabled, set top box 106 tunes to transport stream 112. After tuning to the transport stream, set top box 106 begins decoding the transport stream to obtain the graphical images for GUI controller 110.

Referring back to FIG. 1, once a user selects a GUI, set top box 106 needs to begin displaying a menu on display 108. Since the user just enabled the GUI, the first menu screen to be displayed is Menu 1-1 as communicated by image 202 of FIG. 3. In this example embodiment, image 202 displays the current programs for each data stream being transmitted to set top box 106.

At this time, set top box 106 looks up the identification code that is associated with menu 202. After finding the identification code, set top box 106 searches its cache to find frames that have the correct identification code. Set top box 106 finds the frames that were cached from the GUI GOP 220 of FIG. 2. Once the frames are located, GUI controller 110 in set top box 106 begins processing each frame to obtain the image data from which each frame was created. GUI controller 110 then uses the image 202 to create Menu 1-1 of FIG. 4, which is transmitted to display 108, via line 116.

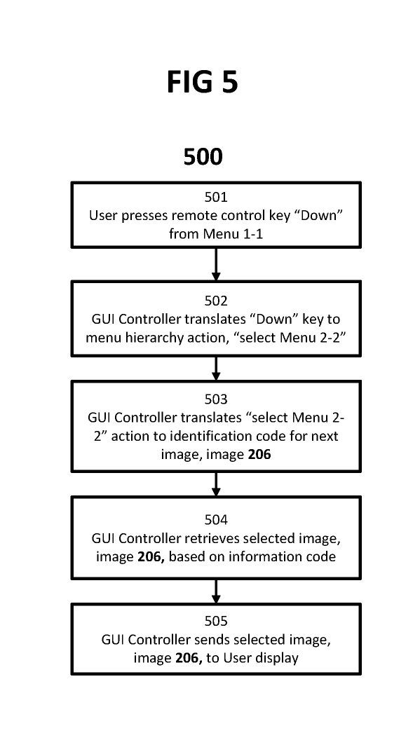

In this example embodiment, image 202 shows Menu 1-1, a listing of all television programs that are currently available. After looking at image 202, a user wants to have more options, and selects a remote control key (“Down”) directing the STB to display Menu 2-1. Menu 2-1 corresponds to image 206 of FIG. 4. An example embodiment of a user selecting sub menu 206 will now be further described with reference to FIG. 5.

In Step 501, the user selects the “Down” remote control key, indicating they wish to view Menu 2-1.

In Step 502, GUI controller 110 on set top box 106 translates the “down” key press to a menu hierarchy action, moving down one layer in the hierarchy from Menu 1-1. The action corresponds to selecting Menu 2-1.

In Step 503, GUI controller 110 looks up the identification code corresponding to Menu 2-1.

In Step 504, GUI controller 110 then locates the frames that were cached from the group of pictures in data package 220 of FIG. 2 and retrieves image 206.

In step 505, GUI controller 110 then uses the image 206 of FIG. 2 which is transmitted to display 108 to display Menu 2-1.

Similarly to the above sequence, a user might select Menu 3-2, for example, by entering the GUI at image 202, then selecting the “down” button to reach image 206, Menu 2-1. The user could continue by selecting the “down” button again to reach Menu 3-1, image 210, then selecting the “right” arrow to reach Menu 3-2, image 212. Alternatively, a user might press “12” in sequence to reach Menu 3-2 from Menu 1-1. A person skilled in the art would realize that there are many navigation options available to navigate the hierarchy of GUI screens within menu 400.

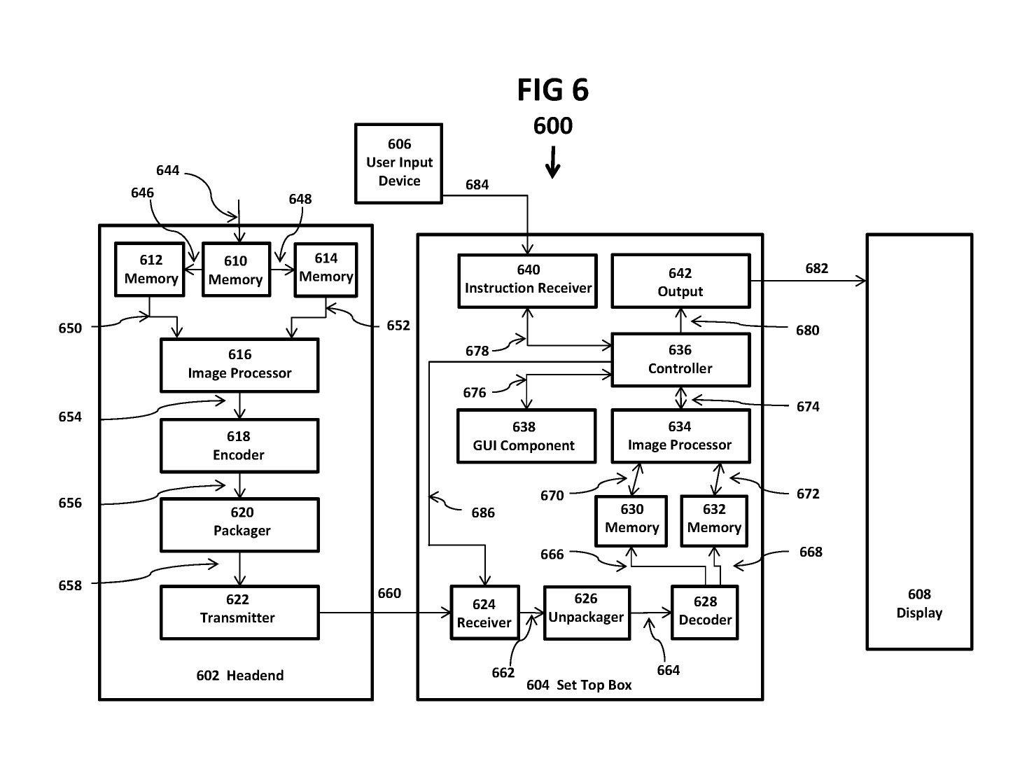

FIG. 6 illustrates a block diagram of a system 600, in accordance with aspects of the present invention.

As illustrated in the figure, system 600 includes a head-end 602, a set top box 604, a user input 606, and a display 608.

Head-end 602 further includes a memory 610, a memory 612, a memory 614, an image processor 616, an encoder 618, a packaging component 620, and a transmitter 622.

In this example, memory 610, memory 612, memory 614, image processor 616, encoder 618, packaging component 620, and transmitter 622 are illustrated as individual devices. However, in some embodiments, at least two of memory 610, memory 612, memory 614, image processor 616, encoder 618, packaging component 620, and transmitter 622 may be combined as a unitary device. Further, in some embodiments, at least one of memory 610, memory 612, memory 614, image processor 616, encoder 618, packaging component 620, and transmitter 622 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Set top box 604 further includes a receiver 624, an unpackaging component 626, a decoder 628, a memory 630, a memory 632, an image processor 634, a controller 636, a GUI component 638, an instructional receiver 640, and an output component 642.

In this example, receiver 624, unpackaging component 626, decoder 628, memory 630, memory 632, image processor 634, controller 636, GUI component 638, instructional receiver 640, and output component 642 are illustrated as individual devices. However, in some embodiments, at least two of receiver 624, unpackaging component 626, decoder 628, memory 630, memory 632, image processor 634, controller 636, GUI component 638, instructional receiver 640, and output component 642 may be combined as a unitary device. Further, in some embodiments, at least one of receiver 624, unpackaging component 626, decoder 628, memory 630, memory 632, image processor 634, controller 636, GUI component 638, instructional receiver 640, and output component 642 may be implemented as a computer having tangible computer-readable media for carrying or having computer-executable instructions or data structures stored thereon.

User input 606 is operable to transmit instructions to instructional receiver 640 of set top box 604, via line 684. User input 606 may be any known type of user input, a non-limiting example of which includes an infra-red remote control.

Display 408 is operable to receive and display image data received from output component 642 of set top box 604, via a communication line 682. Communication line 682 may be any known type of wired or wireless communication line.

Memory 610 is operable to receive and store image data from a content source (not shown), via a communication line 644. The content source (not shown) may be any known type of content source, non-limiting examples of which include an image processor and an external memory. Memory 610 is additionally operable to transmit stored image data for a first GUI menu to memory 612, via a communication line 646, and to transmit stored image data for a second GUI menu to memory 614, via a communication line 648. Each of communication lines 644, 646 and 648 may be any known type of wired or wireless communication line.

Memory 612 is operable to receive and store image data received, via line 646. Memory 612 is additionally operable to transmit stored image data to image processor 616, via line 650. Memory 614 is operable to receive and store image data received, via line 648. Memory 614 is additionally operable to transmit stored image data to image processor 616, via a communication line 652. Communication line 652 may be any known type of wired or wireless communication line.

Image processor 616 is operable to process image data received, via a communication line 650 and communication line 652, and transmit the processed image data to encoder 618, via a communication line 654. Each of communication lines 650, 652 and 654 may be any known type of wired or wireless communication line.

Encoder 618 is operable receive image data, via a communication line 654, and encode the image data. Encoder 618 is additionally operable to transmit the encoded image to packaging component 620, via a communication line 656. Communication line 656 may be any known type of wired or wireless communication line. In this example embodiment, encoder 618 encodes the image data into MPEG format. In other non-limiting example embodiments the image data may be encoded into OGG, VOB, FLV format.

Packing component 620 is operable to receive GoPs from encoder 618, via communication line 656. Packaging component 620 is additionally operable to package the GoP as payload and create a header based on the payload. Packaging component 620 is further operable to package the payload and header into a transport package, and transmit the transport package to transmitter 622, via a communication line 658. Communication line 658 may be any known type of wired or wireless communication line.

Transmitter 622 is operable to transmit transport packages received, via communication line 658, to receiver 624 of set top box 604, via a communication line 660. In this example embodiment, transmitter 622 transmits transport packages via a cable line. In other example embodiments, transmitter 622 may transmit transport packages over an internet protocol stream or a broadcast channel.

Receiver 624 is operable to transmit transport packages received from transmitter 622 of head-end 602, via communication line 660, to unpackaging component 626, via a communication line 662. Communication line 662 may be any known type of wired or wireless communication line.

Unpackaging component 626 is operable to unpackage a transport package received, via line 662, to obtain a GoP. Unpackaging component 626 is additionally operable to transmit the GoP to decoder 628, via a communication line 664. Communication line 664 may be any known type of wired or wireless communication line.

Decoder 628 may be any device or system that is able to decode a GoP to obtain decoded GUI data from the encoded GUI data. Decoder 628 is operable to decode a GoP received, via communication line 664, to obtain image data. Decoder 628 is additionally operable to transmit the image data obtained from the data package to memory 630, via a communication line 666, and to memory 632, via a communication line 668. Each of communication lines 666 and 668 may be any known type of wired or wireless communication line.

When decoder 628 decodes the GOP, it obtains the group of pictures that was originally encoded by encoder 618, of head-end 602. Decoder 628 can then transmit each frame in the group of pictures to be stored in memory. In this example embodiment, decoder 628 transmits image data for a first GUI menu to memory 630, image data for a second GUI menu to memory 632.

Memory 630 is operable to receive and store image data received, via communication line 666. Memory 630 is also operable to transmit stored image data to image processor 434, via a bi-directional communication line 670. Memory 632 is operable to receive and store image data received, via communication line 668. Memory 632 is also operable to transmit stored image data to image processor 634, via a bi-directional communication line 672. Each of bi-directional communication lines 670 and 672 may be any known type of wired or wireless communication line.

Image processor 634 is operable to retrieve image data stored by memory 630, via bi-directional communication line 670, and memory 632, via bi-directional communication line 672 based on instructions received from controller 636, via a bi-directional line 674. Bi-directional communication line 674 may be any known type of wired or wireless communication line. Image processor 634 is additionally operable to process image data such that it is in a form that can be displayed by display 608. Image processor 634 is further operable to transmit image data to controller 636, via bi-directional communication line 674.

Controller 636 is operable to transmit image data it receives, via bi-directional communication line 674, to output component 642, via a communication line 680. Controller 636 is additionally operable to receive instructions from instructional receiver 640, via a communication line 678. Controller 636 is further operable to obtain and transmit image data based on instructions received from GUI component 638, via a bi-directional communication line 676. Controller 636 is yet further operable to instruct receiver 624 to tune to different channels, via a communication line 686. Each of communication lines 678, 680 and 686, and bi-directional communication line 676 may be any known type of wired or wireless communication line.

Controller 636 may be any device or system that associates user interface instructions from GUI component 638 with decoded GUI data provided by decoder 628 to generate a graphic user interface (GGUI) package. Controller 636 is also able to perform a function based on receipt of an instruction signal from user input 606.

When a GUI is enabled, controller 636 will instruct image processor 634 to retrieve image data that corresponds to the current GUI screen from either memory 630 or memory 632. Image processor 634 retrieves the required image data based on the identification code that was embedded into each image by encoder 618. Image processor 634 then transmits the image data back to controller 636, which then transmits the image data to be displayed.

If a user transmits an instruction, such as selecting a different menu, controller 636 will compare the received instruction along with the current GUI screen with a list of instructions stored on GUI component 638. If the instructions indicate that a new menu screen should be displayed after the comparison, controller 636 will instruct image processor 634 to retrieve the image data from memory 630 or memory 632, based on the embedded identification codes that correspond to the new menu screen to be displayed. After the new image data is retrieved, controller 636 will transmit the image data to be displayed by display 408.

GUI component 638 is operable to store GUI instructions that will be associated with respective GUI images. In other words, GUI component 638 provides the instructions associated with the image of a menu. GUI component is further operable to transmit GUI instructions to controller 636, via bi-directional line 676.

Instructional receiver 640 operable to receive instructions from user input 406, via line 684. Instructional receiver 640 is additionally operable to transmit the received instructions to controller 636, via line 678.

Output component 642 is operable to receive image data from controller 636, via line 680. Output component 642 is additionally operable to transmit image data to display 408, via line 682.

In operation, image data for a GUI is transmitted from a content source to memory 610, via line 644, which then stores the data. In some embodiments, as memory 610 begins to run out of storage space, it begins to parse the stored image data into image data for a first GUI menu and image data for a second GUI menu. In other embodiments, the stored image data can be parsed even when memory is not running out of space. The image data for a first GUI menu is transmitted to be stored by memory 612, via line 646, and the image data for the second GUI menu is transmitted to be stored by memory 614, via line 652.

Next, memory 612 retrieves the stored image data for the first GUI menu and transmits it to image processor 616, via line 650. Image processor 616 can have limitations on its processing ability, such as to only process so much data at a time, so memory 612 may only transmit 12 frames of image data and continue to store the rest until a later time. Of course this is merely an example, non-limiting embodiment, wherein an exemplary number of frames is discussed.

Once the data for the first image is received by image processor 616, it creates an I-Frame based on the image data. After creating the I-Frame, image processor 616 transmits the I-Frame to encoder 618, via line 654. After receiving the I-Frame, encoder 618 embeds an identification code so the I-Frame may be identified at a later time. Encoder 618 then uses the I-Frame as a first anchor in a new group of pictures. As the rest of the image data is received, image processor 616 creates I-frames or B-Frames or P-Frames based on the image data and the initial I-Frame. Once all needed frames are created, they are transmitted to encoder 618 which then embeds identification codes and adds the frames to the current group of pictures. Next, encoder 618 encodes the group of pictures, which it then transmits to packaging component 620, via line 656.

After receiving the encoded GoP, packaging component 620 generates a header for the GoP which identifies that the payload is image data for the first GUI menu. Next, the header and the encoded GoP are combined to create a transport package. The transport package is then sent to transmitter 622, via line 658. After receiving the transport package, transmitter 622 then transmits the transport package to receiver 624 of set top box 604, via line 660.

In an example embodiment, when the image data is packaged and transmitted, memory 614 retrieves 12 frames of stored image data for the second GUI menu, which it then transmits to image processor 616, via line 652. The process of creating a transport package based on image data from memory 614 is the same as it was for creating a transport package based on image data from memory 612 as described above.

At this time, receiver 624 receives the transport package, via line 660, which was created based on image data for the first GUI menu. After receiving the transport package, receiver 624 transmits the transport package to unpackaging component 626, via line 662. Next, unpackaging component 626 breaks the transport package down into the header and GoP. Unpackaging component 626 reads the header and finds that the GoP contains image data for the first GUI menu. Unpackaging component 626 then transmits the GoP and the header to decoder 628, via line 664.

Once decoder 628 receives the data package, it begins to decode the data package to obtain the original group of pictures that were encoded by encoder 618. After the data package is decoded, decoder 628 transmits each image to be stored into memory based on the header. In this example embodiment, the header identifies the group of images as corresponding to the first GUI menu. As such, decoder 628 then transmits each image to memory 630, via line 666, which then stores the images.

Soon after, receiver 624 receives the transport package that was created based on the image data for the second GUI menu. The process of unpackaging and decoding the second transport package is the same as described above. Once the second transport package has been decoded, decoder 628 examines the header to find that this group of images corresponds to the second GUI menu. Since this group of images belongs to the second GUI menu, decoder transmits each image to memory 632, which then stores each image to be used at a later time.

For purposes of discussion, suppose that during this process a user has been using set top box 604 to watch a television program that just ended. Since the program has just ended, the user would like to look at a listing of television programs that are currently available. To do this, the user presses a listing button on their remote control, which is transmitted as user input 606, via line 684.

Instructional receiver 640 receives user input 606 and transmits it to controller 636, via line 678. At this time, controller 636 sends user input 606 to GUI component 638, via bi-directional line 676. GUI component 638 looks up the instructions that correspond to user input 606, which are then transmitted back to controller 636. The instructions transmitted to controller 636 from GUI component 638 include the identification number of the image data needed for the first GUI menu.

The instructions received from GUI component 638, instruct controller 636 to display the first GUI menu. Controller 636 transmits the identification code contained within the instructions to image processor 634, via bi-directional line 674. After receiving the identification code for the needed image data, image processor 634 retrieves the frame with the corresponding identification code from memory 630, via bi-directional line 670. Image processor 634 then processes the frame to extract the original image data that was encoded by head-end 602.

Image processor 634 then transmits the retrieved image data back to controller 636. Having received the image data, controller 636 constructs a GUI menu using the image data which it then transmits to output component 642, via line 680. Output component 642 then transmits the image GUI menu to be displayed by display 608, via line 682. At this time, a user is able to view all of the television programs that are currently available. Set top box 606 will continue operating in this manner until a user deactivates the GUI.

In this example embodiment only one video stream was used to transmit image data to be used in constructing a GUI for set top box 606. In other example embodiments, multiple streams may be transmitted, each representing a different GUI skin. In this manner, a user may choose a GUI skin that they like and the set top box may then tune to the corresponding stream to retrieve the correct transport stream.

A problem with the current system and method for a set top box GUI is that there is only a limited amount of incoming bandwidth available to a set top box. Since each menu screen for a GUI is transmitted on a separate stream, transmitting all of the screens simultaneously to a set top box places a strain on the bandwidth, creating a slow and unresponsive GUI.

The present invention uses a system and method of transmitting a set top box GUI as a single video stream. At the head-end, the image data for each GUI screen is embedded with an identification code and encoded into video frames. The frames are then multiplexed into a transport stream which is transmitted to a set top box.

The set top box can then decode the transport stream to retrieve the video frames and store them in memory to be used later. When a GUI is activated, the controller of a set top box can look up the identification codes that correspond to a GUI screen and then retrieve the video frames based on the identification codes each frame was embedded with at the head-end.

After the video frames are retrieved, they can be processed to retrieve the original image data. The image data can then be used to construct a GUI screen to be transmitted and displayed for a user. In this manner, an entire GUI can be transmitted as a single video stream. Multiple streams may be transmitted with GUI data, each stream representing a different GUI skin. Using a different stream for each GUI skin allows multiple skins to be available to a user while still using only a limited amount of bandwidth.

In the drawings and specification, there have been disclosed embodiments of the invention and, although specific terms are employed, they are used in a generic and descriptive sense only and not for purposes of limitation, the scope of the invention being set forth in the following claims.

1. A method of providing a graphical user interface, said method comprising:
associating a hierarchy of video images with a respective hierarchy of identification codes, wherein each video image provides a static full screen image of the graphical user interface;
associating user remote control selections with traversing the hierarchy of identification codes;
receiving a remote control selection, wherein a user's remote control selection operates to traverse the hierarchy of identification codes;
determining the identification code selected by the user's remote control selection; and
selecting one video image within said hierarchy of video images corresponding to said identification code.

2. The method of claim 1, wherein the hierarchy of video images comprises a graphical user interface menu.

3. A method of generating a graphical user interface, said method comprising:
creating a set of video images that comprises the images of the graphical user interface menu, wherein each video image provides a static full screen image of the graphical user interface;
associating the hierarchy of video images with a respective hierarchy of identification codes;
encoding the video images; and
embedding an associated identification code into each encoded video image.

4. The method of claim 3 further comprising:
forming a data package comprised of the encoded set of video images; and
storing the data package for later transmission.

5. The method of claim 4 wherein: said data package is an MPEG Group of Pictures.

6. The method of claim 3 further comprising:
forming a data package comprised of the encoded set of video images; and
transmitting the data package to a set top box in response to a user action.

7. The method of claim 3 further comprising:
creating a second set of video images that comprises an alternative graphical user interface menu;
associating the second set of video images with the respective hierarchical structure of claim 3;
associating the second hierarchy of video images with the respective hierarchy of identification codes of claim 3;
encoding the second set of video images; and
embedding the associated identification codes into each encoded image.

8. The method of claim 7 further comprising:
forming two data packages comprised of the first and second sets of encoded video images; and
transmitting both sets of data packages to the same set top box to provide two alternative graphical user interface menus.

9. A video receiver device comprising:
a receiver operable to receive an encoded data package having a set of discrete encoded video images and a corresponding set of identification codes, each discrete encoded video image corresponding to a static full screen image of a graphical user interface;
a decoder operable to decode the encoded data package to obtain decoded video image data, wherein each decoded static full screen video image is associated with a corresponding code;
a memory having user interface instructions stored therein;
a controller operable to associate the user interface instructions with said decoded video images and said associated identification codes to generate a graphical user interface package;
a receiver operable to receive user control signals; and
wherein said graphical user interface package enables input of user control signals to control the graphical user interface based, at least in part, on a user control signal and at least one identification code.

10. The device of claim 9,
wherein said receiver is operable to receive the encoded data package as an MPEG group of pictures, and
wherein said decoder is operable to decode the encoded data package to obtain decoded GUI data from one of an intra frame and an inter frame of one of the MPEG group of pictures.

11. A method of supporting a graphical user interface, said method comprising:
receiving a transport package having a header and a payload, the payload corresponding to a data package, the data package having been created based on a set of encoded images, the set of encoded images corresponding to a set of static full screen graphical user interface images and respective identification codes, unpackaging the transport package to obtain the data package;
decoding the data package to obtain the set of image data and respective identification codes;
storing the set of image data and identification codes;
receiving an instruction from a user; and
selecting one of the static full screen graphical user interface images based at least in part on upon the user instruction and the identification codes.

12. The method of claim 11, wherein said receiving a transport package having a header and a payload comprises receiving over an internet protocol stream.

13. The method of claim 11, wherein receiving a transport package having a header and a payload comprises receiving over a broadcast channel.
